(19) United States
(12) Patent Application Publication
(10) Pub. No.: US 2011/0280700 A1
(43) Pub. Date: Nov. 17, 2011

(54) TRANSFER DEVICE

(76) Inventors: Scott K. Uttech, New Berlin, WI (US); Andrew A. Bayer, Oconomowoc, WI (US); Adam C. Hooper, Watertown, WI (US); Kristopher O. Lampe, South Milwaukee, WI (US)

(21) Appl. No.: 13/145,602

(22) PCT Filed: Feb. 2, 2010
(86) PCT No.: PCT/US2010/022924

§ 371 Date: Jul. 21, 2011

Related U.S. Application Data
(60) Provisional application No. 61/149,596, filed on Feb. 3, 2009.

(51) Int. Cl. A61G 3/02

(52) U.S. Cl. 414/540

(57) ABSTRACT

A transfer device to assist a user in moving between vertically displaced locations has a storage enclosure mounted or mountable to the exterior of a motor vehicle. The storage enclosure protects components from external conditions, weather, etc., and typically is made of steel, plastic, etc. A user platform is supported on a drawer assembly that can be completely encased in the storage enclosure. Movement of the drawer assembly is controlled by a drawer extension mechanism that selectively extends and retracts the drawer assembly into and out of the storage enclosure between a stored position completely inside the storage enclosure and an operative position outside the storage enclosure. When the drawer assembly is in an operative position outside the storage enclosure, a platform elevating mechanism can raise and lower the user platform between a lower, compacted storage position and an elevated position using a scissors linkage that links the user platform to a drawer assembly support such as a tray. The elevating mechanism can be an actuator having a cylinder pivotably mounted to the tray and a slidable rod pivotably mounted to the scissors linkage in a manner that permits raising the seat as the rod is extended outwardly from the actuator cylinder. A control system monitors the position of the drawer assembly and the vertical position of the user platform and can prevent undesired operation such as when a motor vehicle engine is still running or a motor vehicle door is closed.

### PRIORITY CLAIM AND CROSS-REFERENCE TO RELATED APPLICATIONS

This application claims the benefit of priority under 35 U.S.C. §119(e) and any other United States or other law of the following: U.S. Ser. No. 61/149,596 (Atty. Docket No. 0201-p21p) filed Feb. 3, 2009, entitled TRANSFER DEVICE, the entire disclosure of which is incorporated herein by reference in its entirety for all purposes.

### TECHNICAL FIELD

Embodiments of the present invention relate generally to methods, systems and apparatus for user transfer devices, such as user seats, user platforms and the like, in connection with motor vehicles and other locations. Several embodiments specifically address use of a transfer seat in connection with moving an individual between a lower seating or other area (e.g., a mobility device such as a wheelchair, power chair, etc.) and an elevated seating area (e.g., a seat in a motor vehicle such as a truck, SUV, car, minivan, etc.).

### BACKGROUND

Many individuals have difficulty moving between locations or positions (for example, seats) that are at different heights. For example, moving into and out of motor vehicles and the like can be particularly challenging, especially for individuals who transfer from a wheelchair, power chair, etc. (referred to as “personal mobility devices”) at a lower level to a normally oriented motor vehicle seat at a higher level. Transfer seats are particularly useful when a given motor vehicle seat is substantially higher than a mobility device from/to which the individual is transferring, even more so with taller motor vehicles such as trucks, SUVs and the like. Systems, apparatus and techniques that provide improved vertical transfer for users would represent a significant advancement in the art. In some specific embodiments, systems, apparatus and techniques that provide improved vertical transfer between vertically displaced seating positions for users of taller motor vehicles, personal mobility vehicles and the like, or in other seating transfer settings likewise would represent a significant advancement in the art.

### SUMMARY

The present invention will be readily understood by the following detailed description in conjunction with the accompanying drawings. Embodiments of the present invention include transfer devices of various types that utilize a low profile storage configuration (that is, compact enough for easy storage when not in use), while still providing a user with improved and simplified mounting of the transfer device and vertical extension (that is, up and down travel) to assist a user in moving between lower and upper positions, whether with regard to seating or otherwise. Various embodiments provide advantages over current and earlier transfer devices, including (without limitation):
in some motor vehicle embodiments, the entire device, other than a control panel, portable control pendant or the like, is external to the passenger compartment of the motor vehicle;
in some motor vehicle embodiments, the compact configuration does not interfere with interior vehicle functionality and U.S. FMVSS (U.S. Federal Motor Vehicle Safety Standards) and CMVSS (Canadian Motor Vehicle Safety Standards) safety features;
in some motor vehicle embodiments, the top of the device storage box might act as a step up or running board (a custom running board for selected applications might integrate the transfer seat storage box, etc.);
in some seating-related embodiments, a removable seat pad allows for changes to seat pad size depending on the application;
in some seating-related embodiments, a rotating upper seat plate helps a user span a gap between the transfer device and the upper position;
user groups benefiting from the transfer device include people who use a walking aid, scooter, manual wheelchair and/or power wheelchair;
some embodiments allow for options such as lights, an audible alarm, motor vehicle locking or other disablement until and unless a transfer seat is in its fully stored configuration and, similarly, transfer device disabling if the motor vehicle door is not open or some other condition exists;
the transfer device storage box can be made of plastic, aluminum, stainless steel, or steel;
some embodiments can use power operation and/or manual operation of an in/out lateral sliding mechanism and/or the up/down vertical elevating mechanism (e.g., a manual backup system can be used by roadside assistance operators, repair personnel, etc.);
the modular designs of some embodiments allow transfer devices be installed and moved from one vehicle or location to another (advantageous for use in connection with leasing, rental vehicles, users who change vehicles often, etc.);
in some motor vehicle embodiments, there is no loss of second row space otherwise used for passenger seating, cargo storage, etc.;
some embodiments can use completely automatic operation (e.g., a single toggle switch);
in some motor vehicle embodiments, there is no loss of FMVSS/CMVSS function (that is, side airbag operation);
some embodiments can be adapted for use as a mini porch lift at stairs/steps when entering a motor home, recreational vehicle (RV) or the like;
in some motor vehicle embodiments, the storage box height can be limited to less than 6 inches for standard truck and SUV sizes (e.g., pickup trucks), and less than 9 inches for RV or other settings.

### BRIEF DESCRIPTION OF DRAWINGS

The present invention will be readily understood by the following detailed description in conjunction with the accompanying drawings, wherein like reference numerals designate like structural elements, and in which:

FIG. 1 is a perspective view of a motor vehicle including a transfer seat according to one or more embodiments of the present invention.

FIG. 2 is a cross-sectional view of the vehicle of FIG. 1 showing one mounting mode for the transfer seat according to one or more embodiments of the present invention.

FIG. 3 is a perspective view of a transfer seat including mounting brackets according to one or more embodiments of the present invention.

FIG. 4 is a perspective view of a transfer device with its drawer assembly extended outside the device storage box according to one or more embodiments of the present invention.

FIG. 5 is a top view of a transfer device with its drawer assembly extended outside the device storage box according to one or more embodiments of the present invention.

FIG. 6 is a cross-sectional view of a transfer device according to one or more embodiments of the present invention, taken along the line 6-6 of FIG. 5.

FIG. 7 is a top plan view of the storage box and the drawer assembly extended outside the device storage box according to one or more embodiments of the present invention.

FIG. 8 is a side view of the user seat/platform elevating mechanism according to one or more embodiments of the present invention in which the elevating mechanism is in its fully collapsed storage position.

FIG. 9 is a cross-sectional view of the elevating mechanism of FIG. 8, taken along the line 9-9 of FIG. 8.

FIG. 10 is a side view of the user seat/platform elevating mechanism according to one or more embodiments of the present invention in which the elevating mechanism is in a partially raised position.

FIG. 11 is a cross-sectional view of the seat elevating mechanism of FIG. 10, taken along the line 11-11 of FIG. 10.

FIG. 12 is a side view of the seat/platform elevating mechanism according to one or more embodiments of the present invention in which the seat elevating mechanism is in its fully raised position.

FIG. 13 is a cross-sectional view of the elevating mechanism of FIG. 12, taken along the line 13-13 of FIG. 12.

FIGS. 14 and 15 are perspective views of a transfer device according to one or more embodiments of the present invention.

FIG. 16 is an exploded view of the seat elevating mechanism according to one or more embodiments of the present invention.

FIGS. 17A-17D are diagrammatic information concerning a Hiwin LAM-1 linear actuator, including one or more embodiments usable with rod position sensors.

FIGS. 18A-18C are performance information concerning Hiwin LAM-1 linear actuators.

### DETAILED DESCRIPTION

The following detailed description of the invention, including the Figures, will refer to one or more invention embodiments, but is not limited to such embodiments. Rather, the detailed description is intended only to be illustrative. Those skilled in the art will readily appreciate that the detailed description given with respect to the Figures is provided for explanatory purposes as the invention extends beyond such specific embodiments. Embodiments of the invention provide transfer devices, transfer seats, transfer platforms and the like that make entering and exiting a vertically-displaced (e.g., elevated or sunken) seating or other area (e.g., a seat in a taller motor vehicle) easier for those with limited mobility, for example individuals having physical handicaps, older individuals, etc. Examples of the present invention will be shown and explained for illustrative purposes primarily in connection with embodiments used to assist in getting into and out of motor vehicle seats, but the invention is not limited to such uses and locations. For example, transfer devices according to embodiments of the present invention can be used to assist individuals in moving from a ground level to an elevated position with regard to a recreational vehicle (also referred to as an “RV”), where the user is more likely to use the transfer device in a standing position, rather than being seated. Other settings and uses will be apparent to those skilled in the art after considering the following disclosure and the Figures provided herewith.

Reference in the specification to “some embodiments,” “one embodiment,” “an embodiment,” “various embodiments,” etc. of the present invention means that a particular feature, structure or characteristic described in connection with such embodiment(s) is included in at least one embodiment of the present invention. Thus, the appearances of such phrases in various places throughout the specification are not necessarily all referring to the same embodiment.

In some embodiments, transferring between an upper motor vehicle seat and a lower seat outside the motor vehicle is facilitated and/or enabled by a transfer seat that is mounted and maintained in a storage position in a box, enclosure and/or other location on the exterior of the motor vehicle, generally beneath the elevated/upper motor vehicle seat. Where the elevated motor vehicle seat is a driver or passenger seat of a taller vehicle such as a truck or SUV, the transfer seat can be mounted beneath or integrated into a rocker panel, running board or the like (in some instances being part of a “step up” on a running board or the like used by individuals who enter the vehicle by “stepping up” into the vehicle instead of using the transfer device).

The transfer device has a storage box or other storage enclosure that protects the components of the transfer device from external conditions, weather, etc., so the storage enclosure typically is made of plastic, aluminum, stainless steel, steel, or any other suitable durable material, depending on factors such as motor vehicle use, available ground clearance of the transfer device, likely weather conditions, likely road conditions, etc. In some embodiments, the storage enclosure is a box defined by and including walls and a side door, a pair of slide guides that are perpendicular to the side door and mounted to inside walls of the box, and a rack mounted to the bottom of the storage box. A drawer assembly (also referred to as a “drawer”) is slidable into and out of the storage box and includes a drawer support (e.g., a tray) screwed, bolted or otherwise coupled to the side door. The phrases “coupled to” and “connected to” and the like are used herein to describe a connection between two elements and/or components and are intended to mean coupled either directly together, or indirectly, for example via one or more intervening elements, where appropriate. A pair of drawer slides are screwed or otherwise coupled to the two side edges of the tray so that each drawer slide engages a storage box slide guide. A drawer assembly extension mechanism (or extend/retract mechanism) coupled to the drawer support includes a motor assembly having a motor that selectively drives a pinion gear engaging the rack. The pinion gear allows the drawer to be extended out from and retracted into the storage box. When the drawer is in its “fully retracted position” wholly inside the storage box, the side door engages the storage box to provide a sufficiently closed and/or sealed enclosure to house and protect transfer device components. When the drawer assembly is in its “fully extended position” extending outside the storage box, operation of a user seat/platform elevating mechanism is enabled according to some embodiments. In various embodiments a control system includes sensors that monitor and/or detect the drawer's extension/retraction position to supply drawer position data to the control system.

The user seat/platform elevating mechanism (also referred to as the “elevating mechanism”) is mounted to the drawer by appropriate means (e.g., bolted or screwed to the tray) and uses an expandable and compactable scissors linkage having a bottom end mounted to the tray and a top end mounted to a seat or other user platform. This permits a very low-height, compact profile when the scissors linkage is in a “fully collapsed position,” and a substantial vertical expansion or extension when the scissors linkage is in its “fully raised position.” Other user platform elevating mechanisms and/or expandable and compactable linkages having compact storage profiles and relatively substantial vertical displacement may be known to those skilled in the art and are deemed to be equivalents to the extent that they can perform equivalently to the scissors linkage disclosed herein. The scissors linkage's bottom end is mounted to permit vertical movement of the linkage upper end (e.g., pivotably fixing the lower ends of two adjoining scissors linkage legs to the tray, and permitting the lower ends of two other scissors linkage legs to slide laterally). An elevating actuator cylinder is pivotably mounted to the tray and a slidable actuator rod is pivotably mounted to the scissors linkage to raise the seat as the rod is extended outwardly from the actuator cylinder. Again, other actuator configurations may be known to those skilled in the art and are deemed to be equivalents to the extent that they can perform equivalently to the actuator disclosed herein.

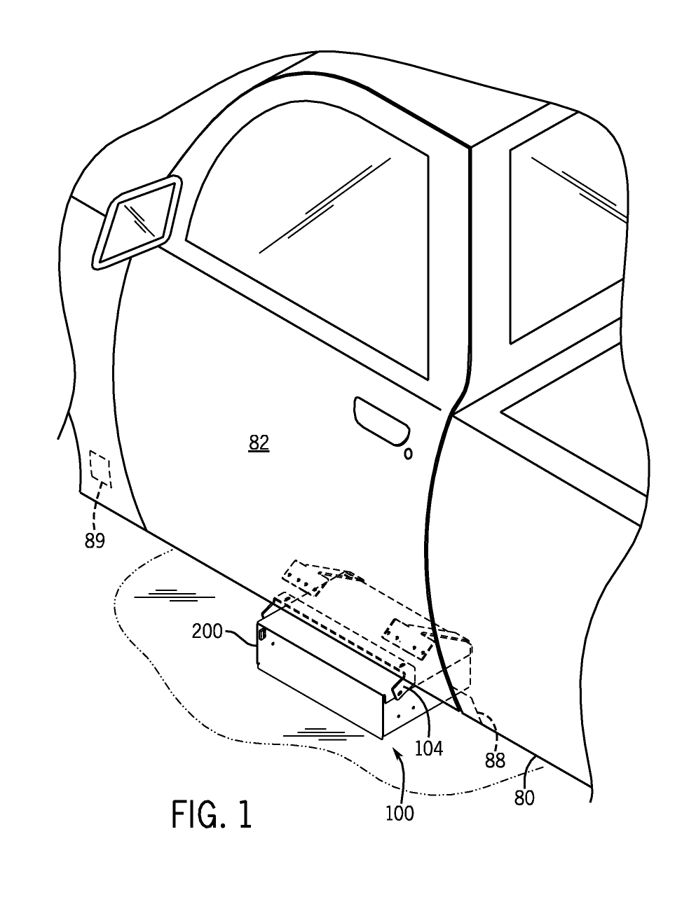

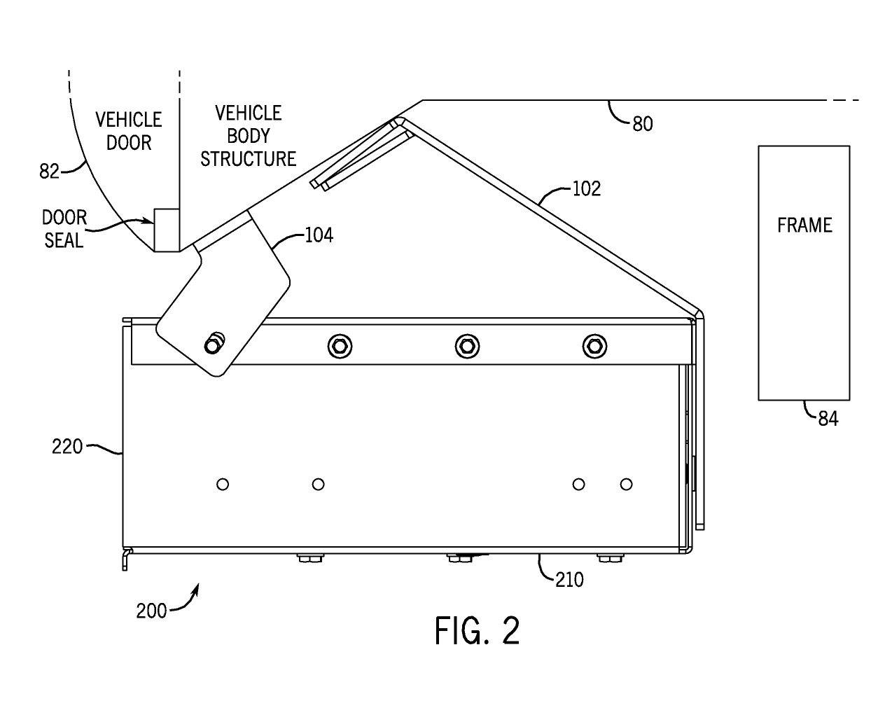

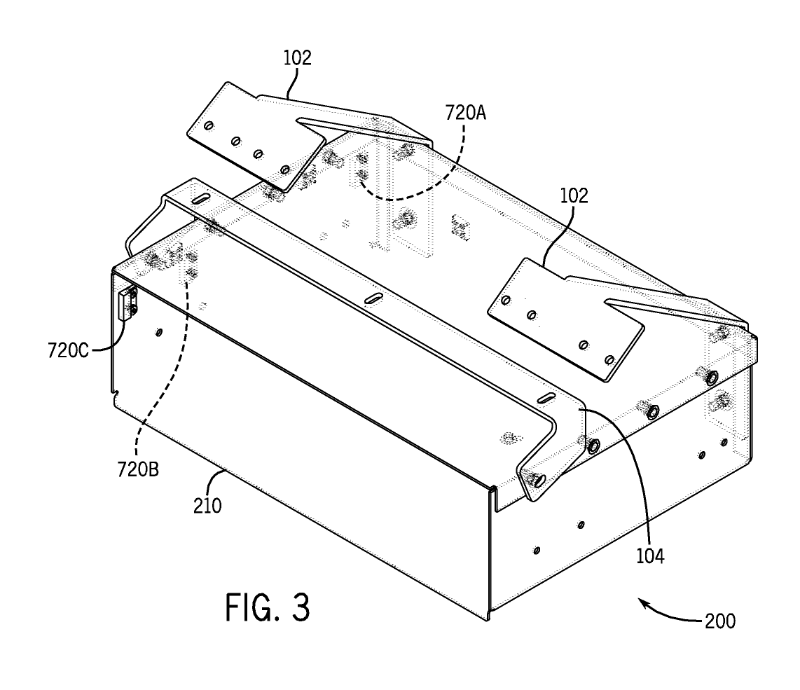

FIG. 1 shows a transfer seat assembly 100 mounted to a motor vehicle 80, such as a pickup truck or SUV having a driver's side door 82. Some embodiments of the transfer device 100 (other than user control(s) and a power source in some embodiments) can be mounted as shown in FIG. 1, entirely outside the passenger cabin of truck 80 and directly below door 82 and its associated passenger cabin seat. FIGS. 2 and 3 illustrate one exemplary scheme for mounting device 100 to motor vehicle 80. A pair of angle brackets 102 are secured to the transfer device storage box 200 using rivet nuts and bolts, screws, or any other suitable means and are secured to motor vehicle 80 using bolts. Likewise, bracket 104 can be secured to storage box 200 using rivet nuts, etc. and secured to the motor vehicle 80 by bolts or the like. As seen in FIG. 2, box 200 can be secured to the motor vehicle body structure rather than the motor vehicle frame, thus simplifying mounting and removal of the transfer device 100. This feature also makes some transfer device embodiments easily transferable among and/or between a number of motor vehicles, which can be ideal for rental vehicles, company motor vehicle fleets, etc. In addition, holes customarily provided in many motor vehicles for running boards and the like can be utilized for securing transfer device 100, thus eliminating or reducing the need for drilling holes in the motor vehicle body structure in some embodiments.

As will be appreciated by those skilled in the art, some embodiments of the transfer device 100 eliminate the need for drilling or otherwise using the vehicle frame 84, which has been necessary with earlier devices, while other embodiments can utilize the frame in this and other ways. Moreover, the entire transfer device 100 (other than a power source (e.g., a motor vehicle battery) and/or part of a control system (e.g., a control panel, control board, portable pendant or the like discussed in more detail below)) is mounted and operates outside the motor vehicle, contrary to many earlier interior-mounted transfer seats. For example, in U.S. Pat. No. 7,207,765, issued to Egan on Apr. 24, 2007, (and a number of related cases pertaining to the same or similar embodiments), the interior-situated transfer seat uses undesirable chassis-mounting studs and the like. These transfer seats suffer from numerous drawbacks and disadvantages, including (but not limited to): preventing full use/range of motion of a second motor vehicle seat adjacent to the transfer seat, requiring studs to be secured to the vehicle chassis (typically requiring drilling, tearing up carpeting and other substantial alterations to the vehicle interior), preventing full utilization of second row seating in vehicles in which the seat is mounted, etc. Some of these transfer seat types also negatively affect motor vehicle side airbag operation, thus impacting vehicle safety.

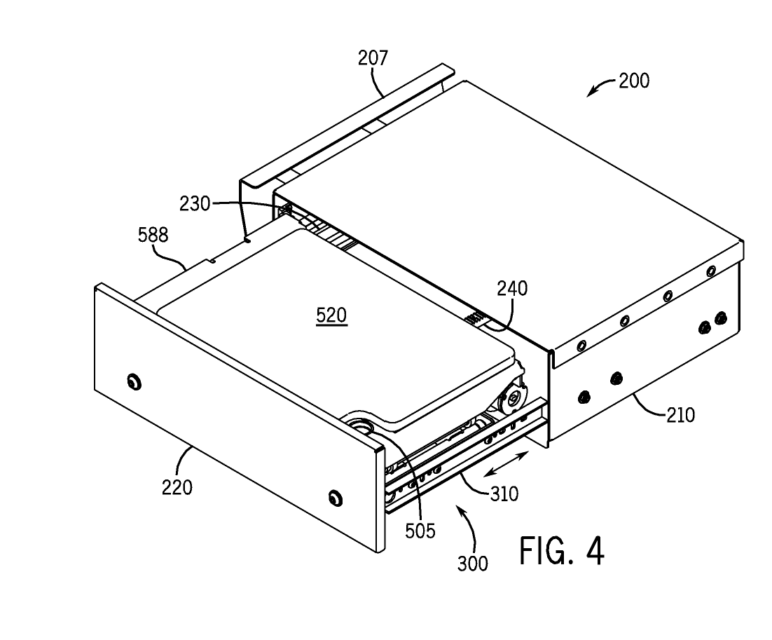

A transfer device 100 according to one or more embodiments disclosed herein moves a “user support platform” such as a seat assembly 500 along two axes of motion, lateral or horizontal movement between drawer extension limits, and vertical movement between lower and upper elevation limits. When used herein, the terms horizontal and vertical refer to movement in a generally horizontal and generally vertical direction. The drawer extension limits can be referred to as a “fully retracted position” and a “fully extended position.” Vertical position limits can be referred to as a lower “fully collapsed position” and an upper “fully raised position” or the like. The storage enclosure 200 of transfer device 100 includes a walled housing 210 and a disengageable side door 220, which can use weather-resistant neoprene to seal the enclosure's interior. Appropriate accommodation can be made in a wall of storage box 200 to provide for wiring and/or other electrical apparatus coupling the contents of enclosure 200 to a control system, motor vehicle battery and/or other apparatus external to storage box 200. Moreover, in embodiments as shown in FIG. 4, but omitted from other embodiments shown in other Figures, a deflector plate 207 can be provided on one side of housing 210 to prevent debris, etc. that might be kicked up from a tire or roadway from damaging transfer device 100.

Slidable within box 200 is a drawer assembly 300 that slides between the fully retracted position, in which the drawer is generally completely enclosed by box 200, and the fully extended position, in which the drawer is extended far enough outside housing 210 that a vertically movable seat or other user platform can be raised and lowered without interference from the housing 210, the motor vehicle, etc. In some embodiments the drawer assembly 300 can be fully extended (to permit initial raising of seat assembly 500 above motor vehicle structure that would otherwise interfere with such vertical movement), then partially retracted to bring a seated user laterally closer to the elevated seat or other location. Depending on size constraints, etc., a detachable or foldable guide such as an armrest, backrest, guide rail, etc. can be used in connection with a user support such as a seat or standing platform.

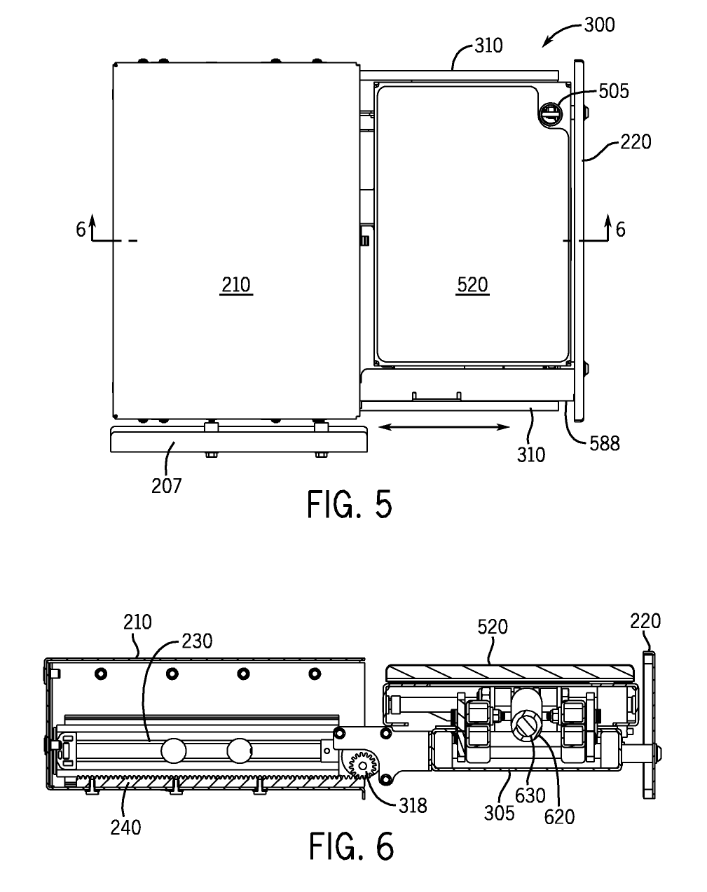

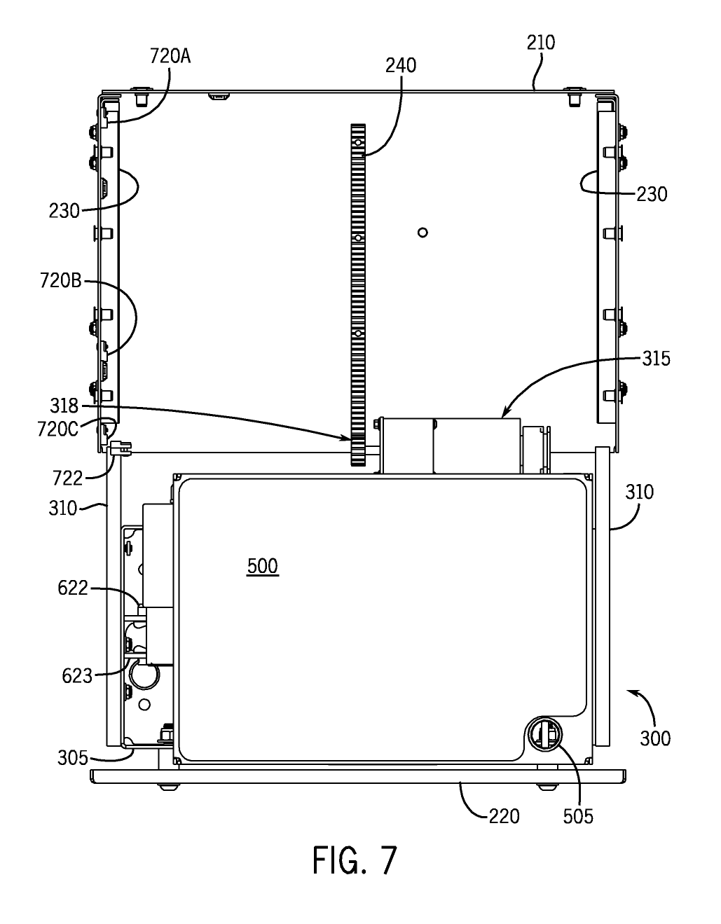

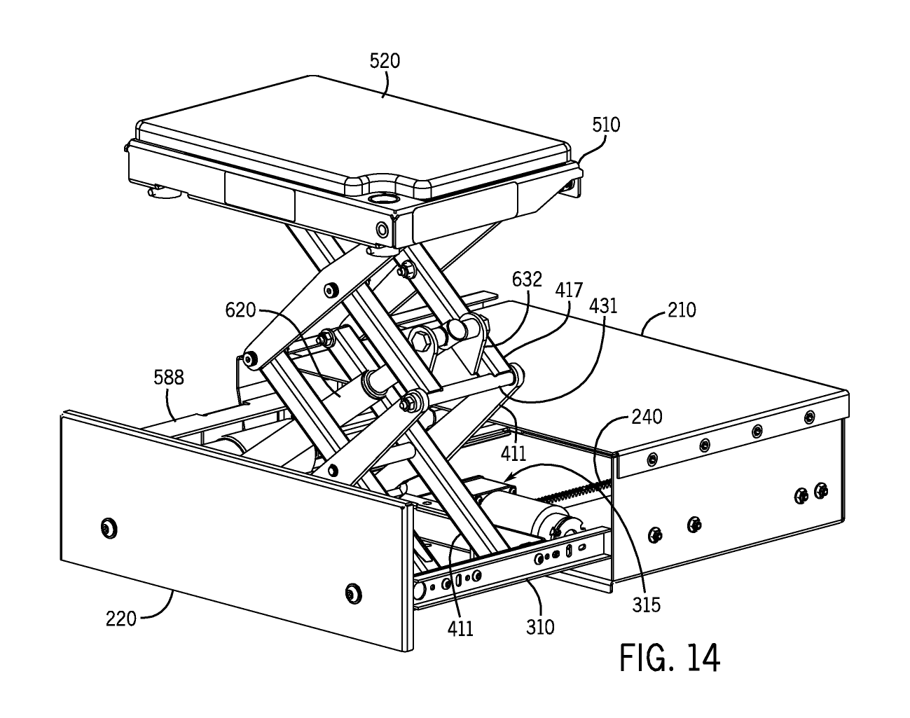

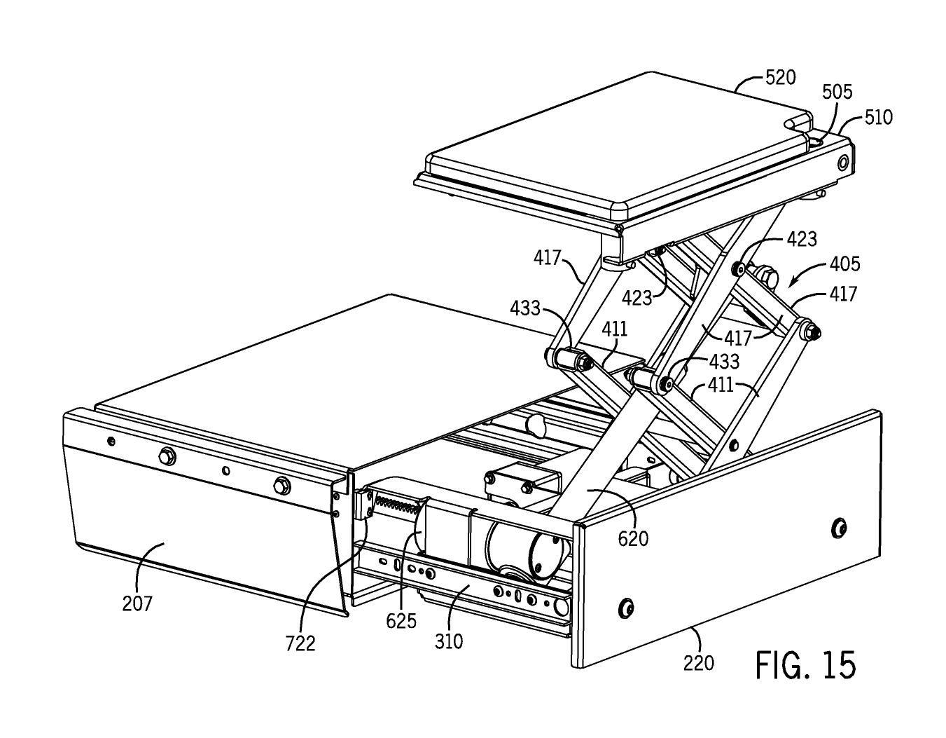

In the embodiment(s) shown in FIGS. 6-9, drawer assembly 300 includes a tray 305 that can be a generally planar steel plate adapted to accommodate any needed features, for example by having sides or lips formed by bending up the edges of tray 305. Drawer extending (and retracting) means includes a rack 240, a control-system-based motor assembly 315 and drawer slide apparatus 310. As seen in FIGS. 5, 7, 14 and 15, two drawer slides 310 are fastened to tray 305 and cooperate with slide guides 230 bolted to the inner walls of box 200. As seen in FIG. 7, the drawer extending means can include rack 240 mounted inside enclosure 200. Motor assembly 315 is coupled to tray 305 and has a motor (mounted inside assembly 315 and not separately numbered) and a pinion gear 318 so that the drawer assembly 300 can be extended and retracted by selectively activating motor assembly 315. Motor assembly 315 can include a motor brake to restrict undesired movement of the drawer assembly 300 when the motor is not activated. Other powered extender/retractor means (e.g., pneumatic, hydraulic or electrical actuating devices, including, e.g., a linear screw or actuator) can be used. Also, manual extending means (e.g., a hand crank similar to an automotive jack, a release switch and pull bar, etc.) can move drawer assembly 300 into and out of box 200. As will be appreciated by those skilled in the art, drawer assembly 300 and its slides 310, etc. and box 200 and its slide guides 230, etc. are constructed to accommodate desired performance characteristics (e.g., maximum user weight, user seat/platform lift ranges, lateral extension limits, etc.). Various other structures can be used as extending means in embodiments of the invention for the drawer assembly 300 and box 200 and such alternatives will be apparent to those skilled in the art.

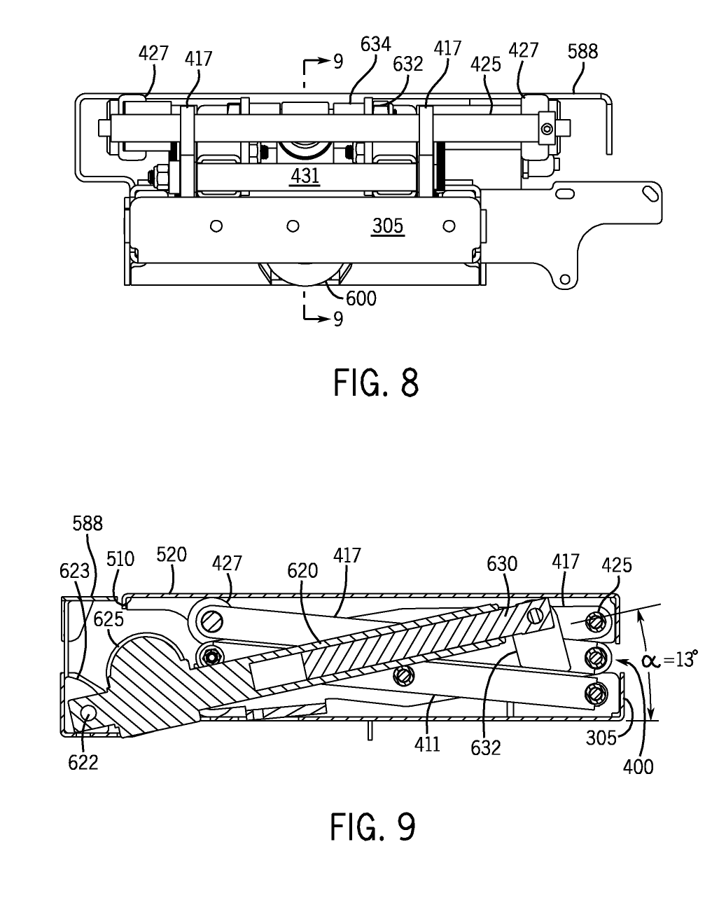

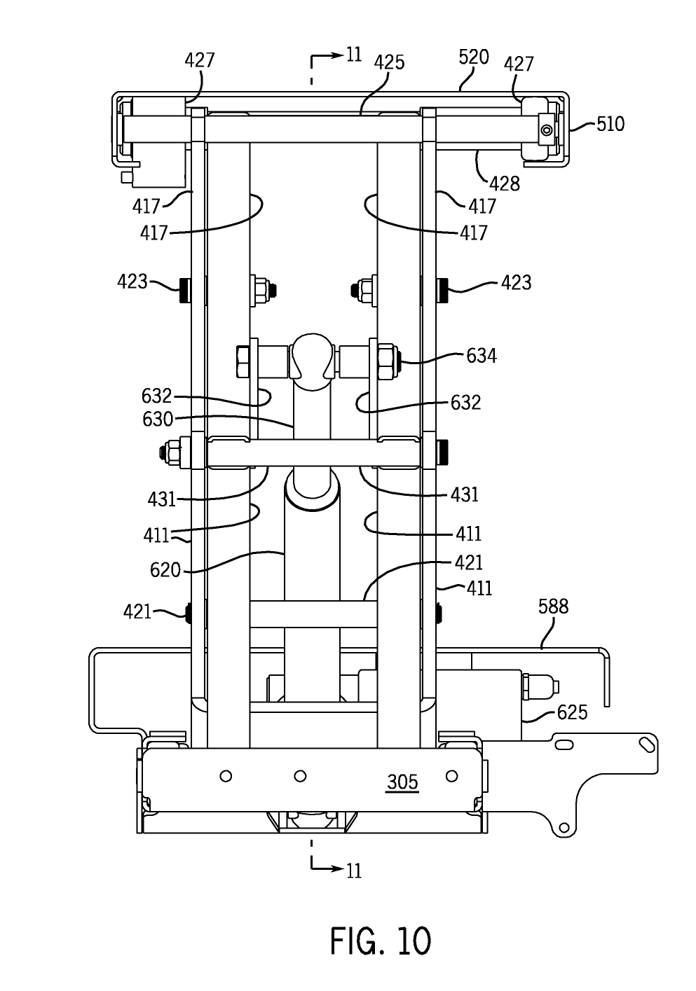

An elevating mechanism 400 is mounted in drawer assembly 300 (e.g., screwed or bolted to tray 305). The elevating mechanism 400 uses an expandable and compactable linkage (e.g., scissors linkage 405) having a very low, compact profile when completely collapsed, while still achieving substantial vertical extension. In embodiments shown in FIGS. 8-13, the overall drawer assembly height (i.e., tray 305, seat elevating mechanism 400 and seat assembly 500) can be compacted to less than 4.5 inches when the seat elevating mechanism is in its fully collapsed position, while expanding to nearly 25 inches in height when in a fully raised position. In some embodiments shown in FIGS. 10-13, the scissors linkage 405 has two double-X-shaped linkage assemblies staked together, top X-linkage 409 (having a total of 4 linkage arms) mounted atop bottom X-linkage 407 (having a total of 4 linkage arms). This scissors linkage configuration provides an advantage in that a user (whether seated or standing) is lifted directly upward; that is, movement is almost directly vertical, without lateral movement outside the dimensions of the extended drawer assembly 300. Earlier systems required substantially more lateral clearance/spacing and thus could not be used in spaces as confined as those in which transfer device embodiments of the present invention will fit and work properly.

As seen FIGS. 9, 11 and 13, the bottom X-linkage 407 has four linkage arms 411, which can be made of square-cross-section steel tubing, flat steel members, etc. Combinations of tubing and flat steel members can provide strength for intended uses of transfer device 100, while also accommodating actual or desired space and size limitations. Two arms 411 are mounted pivotably to tray 305 with an axle or other pivot mounting 413, allowing vertical pivoting of arms 411, but no lateral movement of the arms' bottom ends. Pivot mounting 413 (and mounting 425 noted below) can be steel rods inside of steel sleeves, lubricated or not, or can be other structures that provide appropriate rotational motion between the linked apparatus.

The bottom ends of the other two arms 411 of bottom X-linkage 407 are slidably mounted to tray 305, for example using rollers 415 or the like. Rollers 415 are held in channels 308 defined by tray 305, so that the bottom ends of the arms 411 to which rollers 415 are attached are restricted only to horizontal movement in channels 308. Rollers 415 (and rollers 427 discussed below) can be made of nylon to provide smooth movement and good wear with steel components of seat 100.

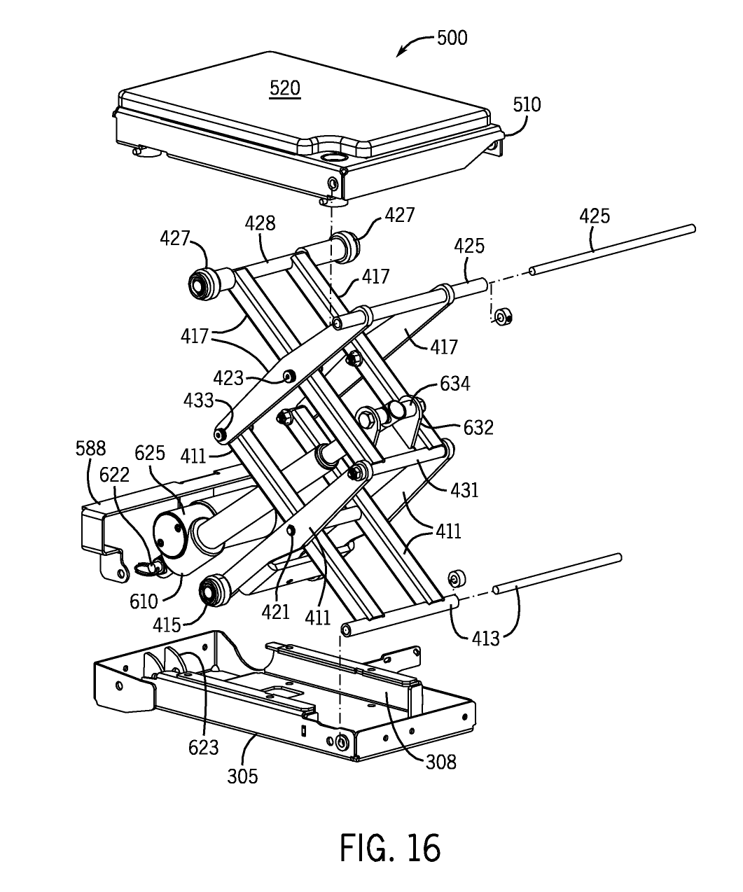

Top X-linkage 409 is constructed similarly, using four linkage arms 417. Arms 411 and arms 417 are pivotably connected to one another to allow the top X-linkage 409 and bottom X-linkage 407 to move cooperatively to raise and lower the user platform (e.g., seat assembly 500). However, as described in more detail below, in some embodiments linkage arm pairs in scissors linkage 405 use two different pivoting connections, either a single long axle or a pivot bolt pair. For example, as seen in FIGS. 10-16, to avoid interfering with the actuating system 600 and to provide clearance space through which the actuating system 600 can move as necessary, the pivot axis of the top X-linkage 409 is a pivot bolt pair 423. Differently, the pivot axis of bottom X-linkage 407 is a single axle 421 that extends completely across and between the arms 411 of the bottom X-linkage 407 because the actuating system 600 does not traverse that pivot axis during raising and lowering of the user platform. Likewise, top X-linkage 409 is coupled to bottom X-linkage 407 using both a single axle pivot 431 and a bolt pivot pair 433, again to accommodate movement of components of the actuating system 600.

A seat assembly 500 shown in the Figures can be any suitable type of user platform and is connected to the upper end of top X-linkage 409 in a manner similar to the mounting of bottom X-linkage 407 to tray 305 (i.e., two pivoting linkage arms 417 coupled to seat assembly 500 and two sliding linkage arms 417 coupled to seat assembly 500). Seat assembly 500 includes a generally horizontal support 510 made of sheet metal such as steel to which a seat cushion or other pad 520 can be mounted, for example using Velcro, fastening tape or the like that allows easy removal, cleaning, replacement, etc. of the pad 520, as well as conversion between use as a seat and use as a standing platform in some embodiments. For standing platform embodiments, a non-slip mat or other surface (e.g., rubber sheet) can be used to provide an appropriate standing surface for a user. Seat assembly 500 can provide a rotating seat to facilitate use of the seat for users entering or exiting a motor vehicle. A number of rotating seat configurations are well known to those skilled in the art. In addition, a footrest 588 can be provided to assist users, as seen in FIGS. 4, 5, 9 and 11. Footrest 588 can be affixed to tray 305 using bolts or any other appropriate footrest mounting means. As seen in FIG. 7, two or more holes 505 or other mounting points permit insertion of an armrest or other guide that a user can configure manually. As will be appreciated by those skilled in the art, a variety of integrated armrest and/or guide configurations (some of which may be selectively foldable or collapsible) also can be used to provide such a feature to a user of the transfer device 100.

A non-translating pivot axle 425, similar to axle 413, connects two arms 417 of top X-linkage 409 to support 510. The other two arms 417 of the top X-linkage 409 are slidably mounted to support 510 using a pair of rollers 427 that are similar to rollers 415 of the bottom X-linkage 407. Rollers 427 can move horizontally within support 510 as top X-linkage 409 is collapsed or extended upward.

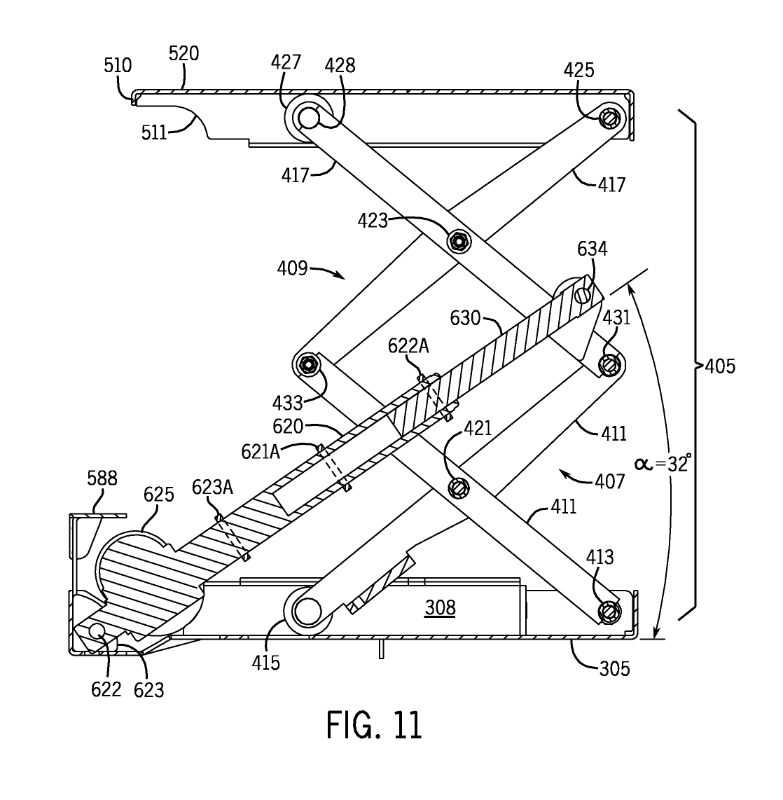

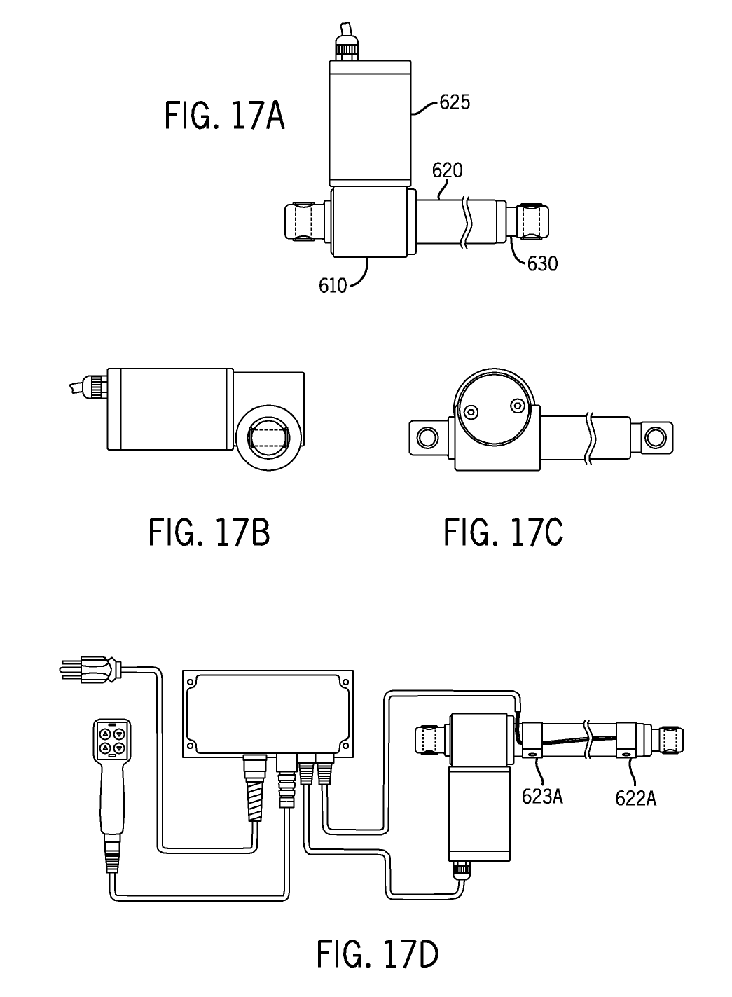

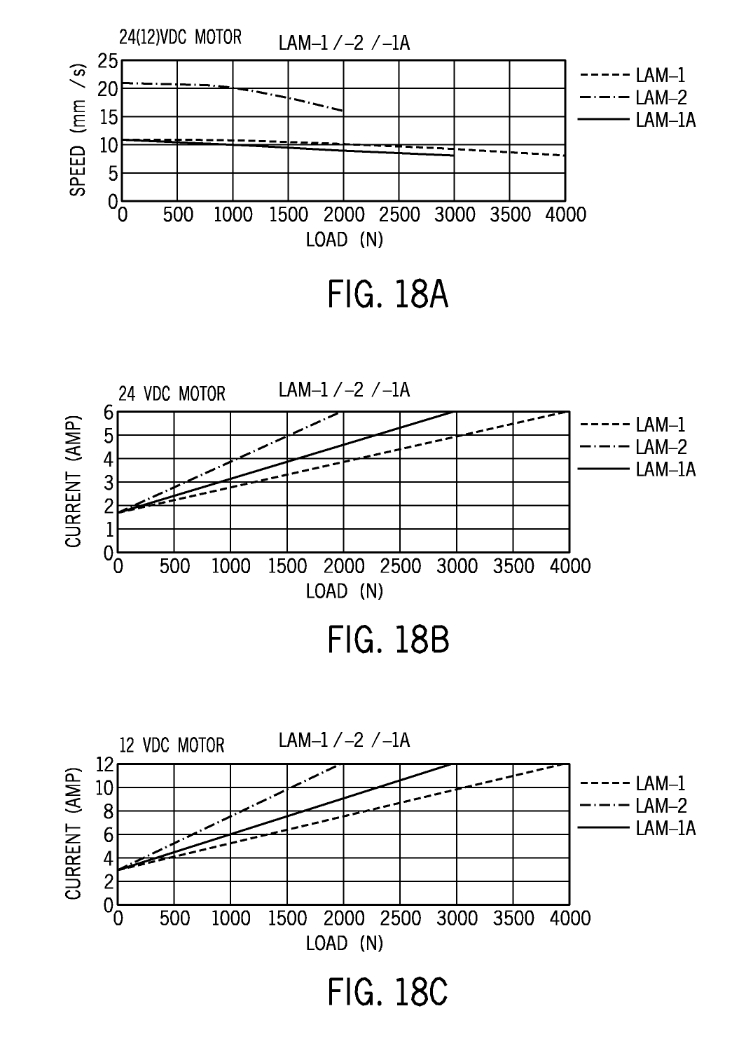

Vertical ascent and descent of the elevating mechanism 400 can be performed in a number of different ways, using a manual and/or powered system. Actuating system 600 in FIGS. 11-16 includes an electric actuator 610 coupled to a cylinder 620 and rod 630 slidable within cylinder 620, drivable using a motor 625 or the like. A suitable actuator is the LAM-1 ballscrew actuator made and sold by Hiwin. Configuration/performance information for such an actuator is provided in FIGS. 17A-17D and FIGS. 18A-18C. This actuator provides a high level of force in a relatively small, compact package in actuating system 600.

One end of cylinder 620 is pivotably mounted to a bracket 623 on tray 305 using a pivot axle 622 to allow for vertical pivoting of the cylinder 620 as elevating mechanism 400 raises and lowers a user seat/platform using scissors linkage 405. Tray 305 can be configured to accommodate the shape and any displacement of actuator 610 (again, it is generally helpful to have the actuator mounted to provide as much vertical inclination upward as possible when elevating mechanism 400 is in its fully collapsed position). One or more cutouts in tray 305 can help accommodate the actuator's position when elevating mechanism 400 is in its fully collapsed position. (In some embodiments, like FIG. 11, support 510 can be configured to accommodate the actuator 610, e.g., by having a contoured lower edge section 511.)

One end of rod 630 slides within cylinder 620 and the other end is pivotably mounted to arms 417 of top X-linkage 409. As seen in FIGS. 10-16, mounting brackets 632 are fixed to arms 417 and hold a pivot axle 634. Axle 634 also is rotatably held by rod 630 so that the end of rod 630 changes angular position relative to arms 417 as support 510 is raised or lowered. The connection of rod 630 to the scissors linkage 405 is configured to take advantage of as much of the translational component of the thrust of the actuator 610 as is practical. Similarly, actuating system 600 is selected to provide a substantial vertical thrust component relative to the scissors linkage 405 so that a significant portion of the actuator's thrust can be used in lifting and/or supporting assembly 500 and a user. The actuator can be mounted in other ways, e.g., horizontally and connected to rollers similar to rollers 415. Packaging and other considerations may make such various actuator mounting schemes more preferable to others.

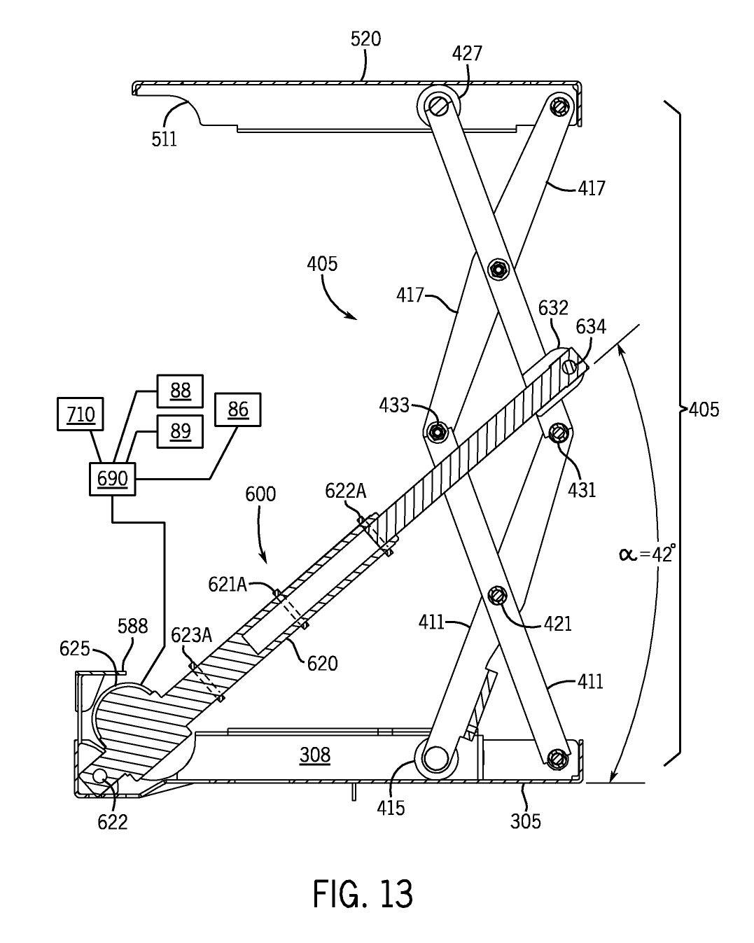

One or both of actuating system 600 and drawer extending means 300 can be powered using a motor vehicle electrical system battery 710 or other electricity source or other required power, as shown in FIG. 13. A user can maintain operational control over the transfer device 100 using a handheld controller 690 or the like throughout operation. Handheld controller 690 can include and/or be coupled to a microprocessor-based control board or the like as part of a transfer device control system. For example, such a control board can be housed in a metal box mounted under the motor vehicle hood. In very simple embodiments, control might be managed by relay controls that provide simpler operation.

Controller 690 can include a pendant coupled to the transfer device 100 by a cable or a wireless system, and can include controls (e.g., one or more buttons or the like) for drawer extension/retraction and user platform raising/lowering. In some embodiments, a single “UP” button and a single “DOWN” button can be provided. Pushing one or the other of such buttons merely continues operation of the transfer device 100 in one direction or the other between two operational endpoints—(1) a “stowed position” in which the seat elevating mechanism is in its fully collapsed and the drawer assembly is in its fully retracted position, and (2) a “fully deployed position” in which the drawer assembly is in its fully extended position and the seat elevating mechanism is in its fully raised position. The controller 690 allows a user or other operator to stop operation of the transfer device 100 in between these two endpoints as needed or desired for use. The controller itself can use a microprocessor, chip, etc. and simple software to drive the extension motor assembly 315 and actuating system 600 as described.

In operation, transfer device 100 is in its stowed position, perhaps while the motor vehicle or other mounting location is in use. Only after the motor vehicle 80 is stopped and in an appropriate vehicle condition (e.g., engine turned off and a particular door open) will operation of transfer device 100 be enabled. Likewise, other conditions might have to be met to reduce the risk of injury or property damage during operation of transfer device 100.

In the motor vehicle seating setting with the transfer device 100 in its fully stowed position, a user activates the drawer extending means 300, for example using a pendant 690 and/or another control device, to extend drawer assembly 300 to its fully extended position. The pinion gear 318 of motor assembly 315 drives drawer assembly 300 out of box 200 using rack 240. The motor can be run until drawer assembly 300 is fully extended (or, in some embodiments, at least is extended far enough to permit operation of the seat elevating mechanism). One or more sensors, detectors, limit switches or the like can be used to assist in operation of the transfer device 100, for example by preventing operation of the seat elevating mechanism 400 unless drawer assembly 300 is extended far enough out to allow raising of the seat assembly 500 without damaging assembly 500, the motor vehicle or other equipment. FIG. 7 shows a drawer assembly position controller that includes sensors 720A, 720B, 720C, mounted inside box 200, that detect a magnet unit 722 or other sensor-activating component on drawer assembly 300. This drawer assembly horizontal position controller detects the position of the magnet unit 722 (and thus the horizontal position of the drawer) and supplies such magnet/drawer position data to the control system control board or the like. Such sensor/detector schemes and equivalents thereto are well known in the art. In the embodiment shown in FIG. 7, once drawer assembly 300 is sufficiently extended, elevating mechanism 400 can raise seat assembly 500. This may occur as a continuous sequence of operations when drawer extending means 300 is activated or may require a user to manually select another activation state (e.g., one or more separate buttons for elevational control on a controller 690).

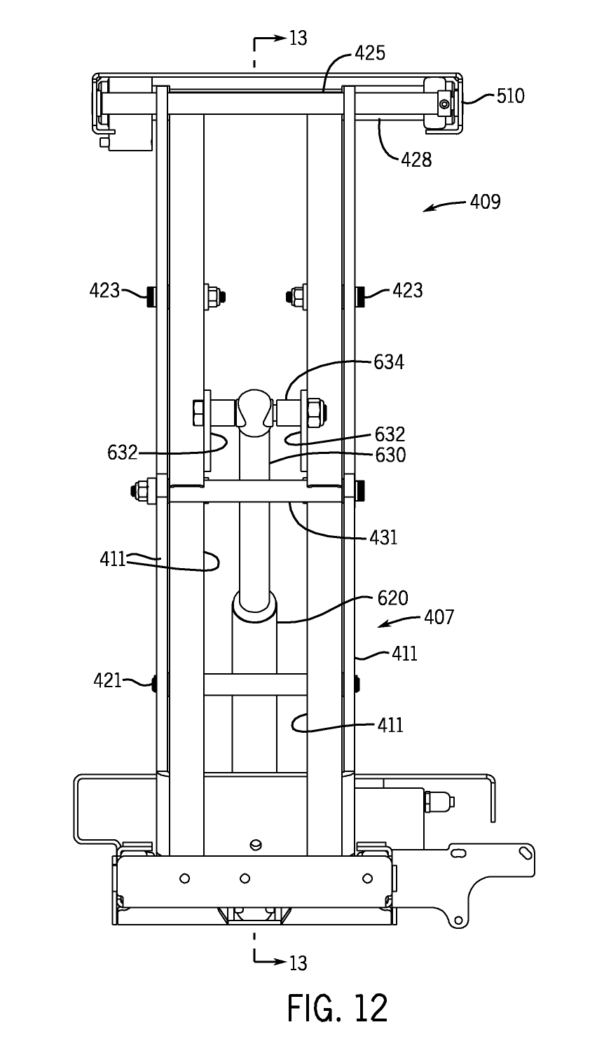

Activation of actuator motor 625 and actuator 610 extends rod 630 to raise seat assembly 500. When the elevating mechanism 400 is in its fully collapsed position, a relatively small component of the total thrust force (F) applied by actuator 610 is directed vertically upward to expand scissors linkage 405. For example, if the vertical angle of rod 630 is α=13° when elevating mechanism 400 is in its fully collapsed position, as shown in FIGS. 8-9, then the vertical force component applied to lift seat assembly 500 and any occupant is (F)*(sin 13°), or approximately F*(0.2250). When scissors linkage 405 reaches its fully raised position, as shown in FIGS. 12-13, this vertical force component has increased appreciably (e.g., if α=42° at full vertical extension, as shown in FIG. 13, then the vertical force component applied to the scissors linkage 405, etc. is approximately F*(0.6691), nearly tripling the upward force applied to lift a user on the user platform). The weight capacity and other operational parameters of the transfer device 100 can thus be calculated depending on the vertical travel limits and actuator angular orientation information available.

In some embodiments, especially in settings where, after drawer assembly 300 is fully extended, a gap remains between seat assembly 500 and an elevated “target position,” such as an elevated motor vehicle seat, extending means 300 can be configured to laterally adjust to move the user closer to the “target position.” When seat assembly 500 is raised enough to clear box 200 and any motor vehicle apparatus, tray 315 can be retracted partially into box 200 to move the seat assembly 500 laterally closer to a target seat or the like once the transfer seat is high enough. Thus, for example, using sensors 720A, 720B, 720C in box 200, the transfer seat system can detect when drawer assembly 300 is far enough out for magnet 722 to trigger sensor 720C. Once sensor 720C is triggered, seat assembly 500 is raised by extending rod 630. When actuator rod 630 is extended far enough to ensure that seat assembly 500 has cleared box 200 and the motor vehicle, then drawer assembly 300 is retracted until magnet 722 is detected by sensor 720B. The position of rod 630 can be determined using a user seat/platform vertical position controller that includes actuator position sensors 621A, 622A on, in or near cylinder 620, which sensors detect the presence/absence of rod 630 in cylinder 620. This seat/platform vertical position controller detects the position of the actuator (and thus the vertical position of the user seat/platform) and supplies the position data to the control system control board or the like. Again, equivalent means will be apparent to those skilled in the art. Actuator position sensors 621A, 622A can be limit switches such as the internal and external types available from Hiwin for use in connection with Hiwin's linear actuators and the like, as seen in FIG. 17. The actuator and drawer sensors can be wired to a control board, as discussed above, to determine unit location/position and thus assist in controlling movement. The extension motor and the actuator motor can be told by the control board when and in what direction to run.

Therefore, beginning with the transfer device 100 in its stowed position, a user activates device 100 to drive the extending means to move drawer assembly 300 to its fully extended position, at which point seat elevating mechanism 400 begins to raise seat assembly 500. When the seat pad 520 is at the proper height for a user to mount device 100, the user does so and then pushes the UP button again to continue raising seat assembly 500. If lateral adjustment means are used to change the lateral positioning of the seat assembly 500 closer to the elevated seat or other transfer target, then seat assembly 500 is raised until it clears box 200 and any motor vehicle or other potentially obstructive structure. Seat assembly 500 moves horizontally to adjust the lateral position of drawer assembly 300 relative to box 200. Once the seat/platform assembly 500 is adjacent to the target seat or other location, the user releases the UP button to stop raising assembly 500. If the target location is adjacent the fully raised position of assembly 500, then actuator system 600 stops automatically.

Lowering of seat elevating mechanism 400 and storage of drawer assembly 300 in box 200 follow a reverse sequence from that described above, including any adjustment needed to compensate for partial retraction of drawer assembly 300 during vertical raising of the seat assembly 500. It should be noted that the travel of actuating system 600 relative to the scissors linkage 405 remains unobstructed due to the use of the bolt pivot pair 433 linking top X-linkage 409 and bottom X-linkage 407 and the bolt pivot pair 423 linking the arms 417 of top X-linkage 409. Thus rod 630 and cylinder 620 travel “inside” or “through” scissors linkage 405 during raising and lowering of seat assembly 500 without interference from linkage 405 itself.

A door safety switch 88 and/or motor status switch 89 shown in FIGS. 1 and 13 can be provided in a motor vehicle where transfer device embodiments are used in a motor vehicle setting. Such safety devices are well known in the art to disable a transfer device unless the correct motor vehicle door is open and/or otherwise in proper position for operation of the transfer device 100. Similarly, a motor vehicle disable switch can also be included in switch 89 to disable operation of the motor vehicle unless the transfer device 100 is in its fully stowed configuration. A user can be warned of extending means and/or lifting means activity by an audible and/or visual warning signal 86 that provides an alert that one or more components of transfer device 100 are in motion. Also, various means can be used in connection with the scissors linkage 405 to ensure that elevating mechanism 400 is completely collapsed/compacted before retraction of drawer assembly 300 into box 200 can begin. In some embodiments, limit switches (like switches 621A, 622A, 623A of FIG. 11) are used on actuator cylinder 620. Alternately, a pushbutton switch can be used beneath the scissors linkage 405 to confirm when elevating mechanism 400 is completely collapsed.

When used as a standing platform transfer device, embodiments of the present invention can be installed on motor homes, caravans, RVs, etc. For example, if used at a doorway for an RV or the like, the transfer device 100 can be mounted below the doorway or can be incorporated/integrated into a set of steps into/out of the doorway. Horizontal and vertical movement of the drawer assembly 300 and elevating mechanism 400 can be augmented to provide easy access for individuals for whom climbing up and down steps is difficult. A railing or other guide can be mounted to assembly 500 to assist with stability, and cushion 520 can be replaced with a high friction mat or the like. Other similar adjustments will be apparent to those skilled in the art.

The many features and advantages of the present invention are apparent from the written description, and thus, the appended claims are intended to cover all such features and advantages of the invention. Further, since numerous modifications and changes will readily occur to those skilled in the art, the present invention is not limited to the exact construction and operation as illustrated and described. Therefore, the described embodiments should be taken as illustrative and not restrictive, and the invention should not be limited to the details given herein but should be defined by the following claims and their full scope of equivalents, whether foreseeable or unforeseeable now or in the future.

1. A motor vehicle occupant transfer device mountable to the exterior of a motor vehicle, the transfer device comprising:
a storage enclosure mountable to an exterior motor vehicle mounting position below a passenger door, the enclosure comprising a door and a plurality of walls defining the enclosure;
a drawer assembly configured to slide horizontally into and out of the enclosure, the drawer assembly comprising:
a drawer support coupled to the enclosure door;
a drawer extension mechanism coupled to the drawer support, the drawer extension mechanism comprising a motor assembly configured to move the drawer horizontally into and out of the enclosure between a fully retracted position inside the enclosure and a fully extended position outside the enclosure; and
an elevating mechanism comprising:
an expandable and compactable scissors linkage mounted between the drawer support and a user platform; and
an actuator configured to expand and compact the scissors linkage between a fully compacted position and a fully expanded position to raise and lower the user platform; and
a control system operatively coupled to a power source, the motor assembly and the actuator and configured to control horizontal movement of the drawer assembly and vertical movement of the user platform.

2. The transfer device of claim 1 wherein the control system comprises:
a first plurality of sensors mounted to the enclosure and configured to detect the horizontal extension of the drawer assembly relative to the enclosure;
a second plurality of sensors mounted to the actuator and configured to detect the vertical position of the user platform based on actuator position; and
a microprocessor-based control board operatively coupled to the first and second pluralities of sensors.

3. The transfer device of claim 4 wherein the control system is configured to partially retract the drawer assembly when the scissors linkage is at an intermediate position between the fully compacted position and a fully expanded position.

4. The transfer device of claim 1 wherein the scissors linkage comprises a plurality of X-linkages mounted vertically together.

5. The transfer device of claim 4 wherein the actuator comprises a cylinder pivotably mounted to the drawer support and a rod slidable within the cylinder and pivotably mounted to the scissors linkage.

6. (canceled)

7. The transfer device of claim 1 wherein the drawer extension mechanism further comprises: a rack affixed to one wall of the plurality of walls in the enclosure; a plurality of drawer slide guides affixed inside the enclosure to two or more of the plurality of walls; and a plurality of drawer slides coupled to the drawer support, wherein each drawer slide engages a drawer slide guide in the enclosure.

8. The transfer device of claim 7 wherein the motor assembly comprises a motor coupled to a pinion gear engaging the rack.

9. The transfer device of claim 4 wherein the enclosure is less than 6 inches in height and further wherein the elevating mechanism raises the user platform more than 20 inches between the fully compacted position and the fully expanded position.

10. The transfer device of claim 2 wherein the control system further comprises one or more disabling switches comprising at least one of the following: a switch to disable the transfer device if the engine of a motor vehicle to which the transfer device is mounted is running; a switch to disable the transfer device if a door of a motor vehicle to which the transfer device is mounted is closed; a switch to disable the ignition of a motor vehicle to which the transfer device is mounted when the drawer assembly is not in its fully retracted position.

11. The transfer device of claim 4 wherein the enclosure is adapted to be a motor vehicle step up when mounted to the exterior of a motor vehicle.

12. The transfer device of claim 11 wherein the enclosure is made of at least one of the following: plastic; aluminum; stainless steel; steel.

13. The transfer device of claim 2 wherein the control system comprises a user pendant comprising one or more buttons controlling operation of the transfer device.

14. The transfer device of claim 4 wherein the user platform is one of the following: a non-rotatable user seat; a rotatable user seat; a user standing support.

15. The transfer device of claim 2 comprising at least one of the following: a warning light operable when the drawer extension mechanism is operating or when the elevating mechanism is operating; an audible warning alarm operable when the drawer extension mechanism is operating or when the elevating mechanism is operating.

16. The transfer device of claim 4 wherein the transfer device is also configured to be operated manually.

17. A transfer device comprising:
a box mountable to the exterior of a motor vehicle, the box comprising a door and a plurality of walls defining the box;
a drawer assembly slidable into and out of the box, the drawer assembly comprising:
a drawer support coupled to the door;
a drawer extension mechanism coupled to the drawer support, the drawer extension mechanism comprising a motor operatively connected to a pinion gear engaging a rack affixed to the interior of the box and adapted to move the drawer generally horizontally into and out of the box between a fully retracted position inside the box and a fully extended position outside the box; and
an elevating mechanism coupled to the drawer support, the elevating mechanism comprising:
a compactable linkage mounted to the drawer support and to a user platform and adapted to raise the user platform vertically; and
an actuator coupled to the drawer support and to the compactable linkage and adapted to move the user platform vertically between a fully collapsed position and a fully raised position.

18. The transfer device of claim 17 further comprising a control system operatively connected to the drawer extension mechanism and to the elevating mechanism to control horizontal movement of the drawer assembly and vertical movement of the user platform.

19. The transfer device of claim 18 wherein the compactable linkage comprises a scissors linkage.

20. The transfer device of claim 19 wherein the compactable linkage comprises a scissors linkage comprising a plurality of X-linkages mounted vertically to one another.

21-25. (canceled)

26. A transfer device comprising a motor vehicle comprising a passenger door, comprising:
a storage box affixed to an exterior motor vehicle mounting position below the passenger door, the storage box comprising:
a plurality of walls and a door defining the storage box; a plurality of drawer slide guides affixed internally to the plurality of walls; and a rack affixed internally to one of the plurality of walls;
a drawer assembly affixed to the door and being slidable into and out of the storage box, the drawer assembly comprising:
a tray coupled to the door and comprising a pair of drawer slides, wherein each drawer slide engages a drawer slide guide in the storage box;
a motor coupled to the tray and to a pinion gear engaging the rack, wherein motor is operatively connected to move the drawer assembly generally horizontally into and out of the storage box between a fully retracted position inside the storage box and a fully extended position outside the storage box below the passenger door; and
a seat elevating mechanism coupled to the tray and comprising:
a scissors linkage mounted to the tray and having a top end mounted to a user seat; and
an actuator pivotably mounted to the scissors linkage and operatively connected to move the user seat between a fully collapsed position and a fully raised position at approximately the same height as the interior passenger seat;
wherein the seat elevating mechanism in its fully collapsed position fits completely within the storage box when the drawer assembly is in its fully retracted position; and
a controller operatively connected to the motor and the actuator and comprising a microprocessor-based control board and one or more buttons for controlling operation of the motor and the actuator.

27-34. (canceled)
